(19) United States
(12) Patent Application Publication
(10) Pub. No.: US 2009/0153483 A1
(43) Pub. Date: Jun. 18, 2009

(54) AMBIDEXTROUS OPERATED MOUSE

(75) Inventors: YI-FENG WENG, Shenzhen City (CN); SHIH-FANG WONG, Tu-Cheng (TW); BING LI, Shenzhen City (CN); YONG YUAN, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO.,LTD., Shenzhen City (CN); HON HAI PRECISION INDUSTRY CO., LTD., Tu-Cheng (TW)

(21) Appl. No.: 12/261,011

(22) Filed: Oct. 29, 2008

(30) Foreign Application Priority Data
Dec. 14, 2007 (CN) 200710203065.6

(51) Int. Cl. G06F 3/033

(52) U.S. Cl. 345/163

(57) ABSTRACT

A method for operating the mouse adapted for right-handed or left-handed includes storing a default operation mode and a current operation mode of the mouse; generating button signals according to click operations exerted on buttons of the mouse; obtaining the current operation mode and the default operation mode; changing the button signals on condition that the default operation mode is different from the current operation mode; and sending the changed button signals to an external computer. A mouse adapted for use by either right-handed or left-handed persons is also provided.

### BACKGROUND

1. Technical Field

The present invention relates to a mouse and, especially, to a mouse adapted for use by either right-handed or left-handed persons.

2. General Background

A computer mouse is an input device for a computer. Depending on the configuration of the operating system of the computer, a computer mouse may have one or more operational buttons. A computer mouse with more than one operational buttons generally has a left button and a right button for generating click signals in response to click operations. People usually use their right hand to operate the mouse. Therefore, a default operation mode configured by the operating system is designated for right-handed people. As to left-handed people or people who need to shift the operation mode frequently, it is inconvenient and troublesome to change the operation mode of the mouse in the operating system.

What is needed, therefore, is an electronic device with a mouse adapted for use by either right-handed or left-handed persons, and a method thereof.

### BRIEF DESCRIPTION OF THE DRAWINGS

The components of the drawings are not necessarily drawn to scale, the emphasis instead being placed upon clearly illustrating the principles of a mouse adapted for use by persons either right-handed or left-handed and method thereof. Moreover, in the drawings, like reference numerals designate corresponding parts throughout the several views.

FIG. 1 is a schematic, plan view of a left/right-hand operated mouse in accordance with an exemplary embodiment.

FIG. 2 is a block diagram of a hardware infrastructure of the mouse of FIG. 1 in accordance with an exemplary embodiment.

FIG. 3 is a block diagram of main function modules of a micro-programmed control unit (MCU) of FIG. 2 in accordance with an exemplary embodiment.

FIG. 4 is a flowchart of an operation mode updating method implemented by a mode-shifting unit of FIG. 3 in accordance with an exemplary embodiment.

FIG. 5 is a flowchart of button signals changing method implemented by a MCU of FIG. 3 in accordance with an exemplary embodiment.

### DETAILED DESCRIPTION OF THE EMBODIMENTS

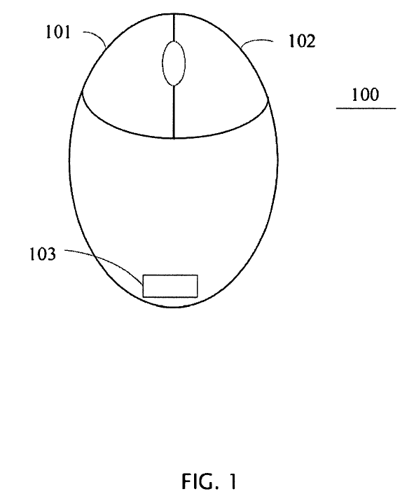

FIG. 1 is a schematic, plan view of a left/right-hand operated mouse in accordance with an exemplary embodiment. The mouse 100 includes a left-button 101, a right-button 102, and a mode-shifting unit 103. The left-button 101 and the right-button 102 are provided for generating corresponding signals, in response to clicks thereon, such as left-button signals and right-button signals. The mode-shifting unit 103 includes a selection switch or button accessible to the user for inputting a desired shifting command. The mode-shifting unit 103 can be positioned in any appropriate position on the mouse 100, such as, for example, the left side, the right side, and the rear side of the mouse 100.

The selection switch or button of the mode-shifting unit 103 has two selectable positions, namely a left-hand selection and a right-hand selection correspondingly representing a left-handed mode and a right-handed mode. In an exemplary embodiment, the selection switch can be turned to the left or the right to switch between the two selectable positions. In another exemplary embodiment, the button can be pressed down or released up to switch between the two selectable positions.

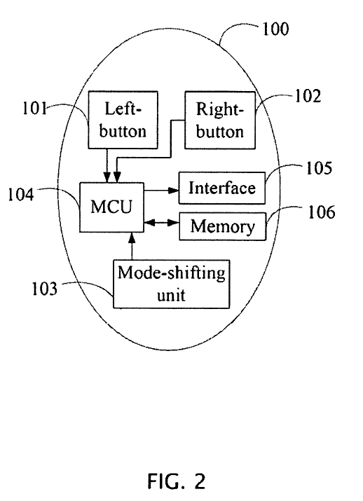

FIG. 2 is a block diagram of a hardware infrastructure of the mouse 100 of FIG. 1. The mouse 100 further includes the micro-programmed control unit (MCU) 104, an interface 105 and a memory 106. The interface 105 is configured for connecting with a computer (unshown). The interface 105 may be one of the followings: a universal serial bus (USB), a wireless transmit interface, or a Bluetooth interface.

The memory 106 stores a default operation mode and a current operation mode of the mouse 100. The default operation mode is provided by the computer that the mouse 100 connected to. In general, the default operation mode is a right-handed mode.

The current operation mode is set to be the default operation mode when the mouse 100 is initialized, and is changed when the selection of the selection switch or position of the button of the mode-shifting unit 103 is changed. That is, the MCU 104 updates the current operation mode after the selection switch or button of the mode-shifting unit 103 is changed. The MCU 104 changes the button signals and transmits the changed button signals to the computer.

The mouse 100 further includes an indicating lamp (not shown) for indicating if the mouse is in the left-handed mode or the right-handed mode. For example, when the indicating lamp is turned on, this means the mouse 100 is in the left-handed mode. The indicating lamp is controlled by the MCU 104.

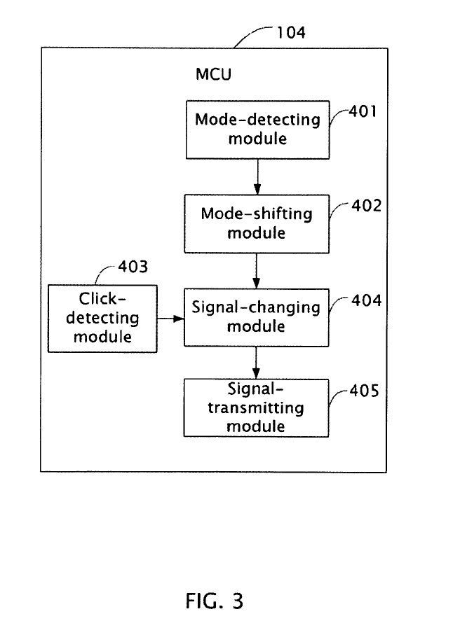

FIG. 3 is a block diagram of main function modules of the MCU 104. The MCU 104 includes a mode-detecting module 401, a mode-shifting module 402, a click-detecting module 403, a signal-changing module 404, and a signal-transmitting module 405.

The mode-detecting module 401 is configured for detecting the current operation mode stored in the memory 106. The mode-shifting module 402 is configured for detecting whether the selection of the selection switch or position of the button of the mode-shifting unit 103 is changed. The click-detecting module 403 is configured for detecting whether the mouse 100 receives a click signal on the left-button 101 or the right-button 102. The signal-changing module 404 determines whether the left-button signals and the right-button signals need to be changed. The signal-transmitting module 405 is configured for transmitting the left-button signals and the right-button signals to the computer.

The signal-changing module 404 changes the button signals based on a relationship between the mode-shifting unit 103 and the current operation mode. If the current operation mode is identical to the default operation mode, the signal-changing module 404 sends the left-button signals or the right-button signals to the computer directly. If the current operation mode is different from the default operation mode, the signal-changing module 404 changes the button-signals before the button-signals are sent to the computer.

In the exemplary embodiment, each button signal is assigned with an identifier for indicating its source. It means the click operation on the left-button or the right-button can be identified through the identifier of the button signal. For example, the identifier of a left-button signal is “001”, and the identifier of a right-button signal is “010”. If the current operation mode is different from the default operation mode, the signal-changing module 404 changes the identifier of the left-button signal “001” to “010”, and the identifier of the right-button signal “010” to “001”.

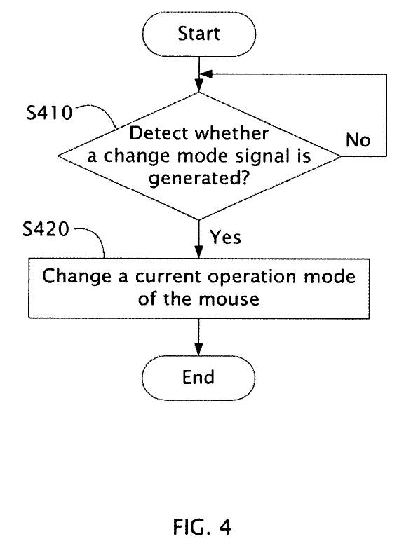

FIG. 4 is a flowchart of describing an operation mode updating method implemented by the mode-shifting unit 103. Depending on the embodiment, certain of the steps described below may be removed, others may be added, and the sequence of steps may be altered.

In step S410, the mode-detecting module 401 detects whether the selection of the selection switch or position of the button of the mode-shifting unit 103 is changed. That is, the mode-detecting module 401 determines whether the mode-shifting unit 103 generates a change mode signal. If the mode-detecting module 401 does not detect the change mode signal, the procedure repeats step S410.

If the mode-detecting module 401 detects the change mode signal, in step S420, the MCU 104 updates the current operation mode of the mouse 100 according to the change mode signal, for example, if the current operation mode is the left-handed mode, the MCU 104 changes the current operation mode into the right-handed mode.

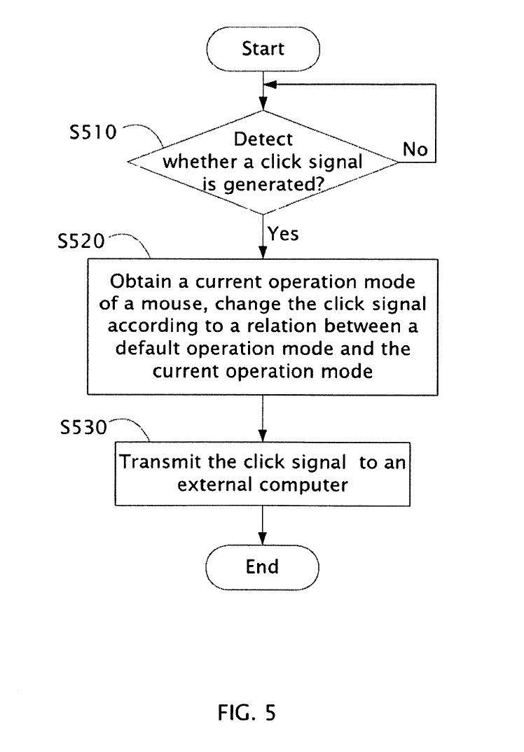

FIG. 5 is a flowchart of describing button signals changing method implemented by the MCU 104. Depending on the embodiment, certain of the steps described below may be removed, others may be added, and the sequence of steps may be altered.

In step S510, the click-detecting module 403 detects whether a click signal generated by the left-button or the right-button. If the click-detecting module 403 doesn't detect the click signal, the procedure repeats step S510.

If the click-detecting module 403 detects the click signal, in step S520, the MCU 104 obtains the current operation mode and the default operation mode, and the signal-changing module 404 decides whether to change the button signals based on the relationship between the default operation mode and the current operation mode. If the current operation mode is identical to the default operation mode, the signal-changing module 404 sends the left-button signals or the right-button signals to the signal-transmitting module 405 directly to the computer. If the current operation mode is different from the default operation mode, the signal-changing module 404 changes the button-signals and sends the converted signal to the signal-transmitting module 405. That is, the signal-changing module 404 changes the identifier of the button-signals before sending the button-signals to the signal-transmitting module 405.

In step S530, the signal-transmitting module 405 transmits the button signals from the signal-changing module 404 to the computer.

Although the present invention has been specifically described on the basis of exemplary embodiment thereof, the invention is not to be construed as being limited thereto. Various changes or modifications may be made to the embodiment without departing from the scope and spirit of the invention.

What is claimed is:

1. A mouse comprising:
a first button capable of generating a right-handed button signal;
a second button capable of generating a left-handed button signal;
a mode-shifting unit having two selectable positions, one of which is a left-hand selection representing a left-handed mode and the other is a right-hand selection representing a right-handed mode;
an interface configured for connecting the mouse to a computer; and
a micro-programmed controller unit (MCU) configured for: a) storing a default operation mode and a current operation mode of the mouse; b) changing the button signals according to a relationship between the current operation mode and the default operation mode; and c) transmitting button signals to the computer.

2. The mouse according to claim 1, wherein the MCU comprises:
a mode-detecting module configured for detecting the current operation mode;
a mode-shifting module configured for detecting whether the selectable position is changed and updating the current operation mode;
a click-detecting module configured for detecting whether the mouse receives a click signal;
a signal-changing module configured for determining whether the button signals need to be changed, and
a signal-transmitting module configured for transmitting the button signals to the computer.

3. The mouse according to claim 2, further comprising a memory, wherein the current operation mode is stored in the memory and changed according to the mode-shifting unit.

4. The mouse according to claim 3, wherein the default operation mode is stored in the memory.

5. The mouse according to claim 1, wherein the mode-shifting unit is a button configured for being pressed down or released up to switch between the two selectable positions.

6. The mouse according to claim 1, wherein the mode-shifting unit is a selection switch configured for being turned to the left or the right to switch between the two selectable positions.

7. The mouse according to claim 1, further comprising an indicating lamp controlled by the MCU and capable of turning on or turning off for indicating the left-handed mode or the right-handed mode.

8. The mouse according to claim 4, wherein the signal-changing module is capable of sending the button signals to the computer directly if the current operation mode is identical to the default operation mode; and the signal-changing module is capable of changing the button-signals before sending to the computer if the current operation mode is different from the default operation mode.

9. The mouse according to claim 8, wherein the signal-changing module is capable of changing an identifier of the left-button signal to an identifier of the right-button signal, and changing the identifier of the right-button signal to the identifier of the right-button signal, if the current operation mode is different from the default operation mode.

10. A method for a mouse adapted for right-handed operation or left-handed operation, comprising:
storing a default operation mode and a current operation mode of the mouse;
generating button signals according to click operations exerted on buttons of the mouse;
obtaining the current operation mode and the default operation mode;
changing the button signals on condition that the default operation mode is different from the current operation mode; and
sending the changed button signals to an external computer.

11. The method according to claim 10, further comprising updating the current operation mode after detecting a change mode signal.

12. The method according to claim 11, wherein the current operation mode is selected from the group consisting of the left-handed mode and the right-handed mode.

13. The method according to claim 11, wherein the default operation mode is selected from the group consisting of the left-handed mode and right-handed mode.
